(19) United States
(12) Patent Application Publication
(10) Pub. No.: US 2026/0029733 A1
(43) Pub. Date: Jan. 29, 2026

(54) IMAGE FORMING APPARATUS AND IMAGE FORMING METHOD

(71) Applicant: SHARP KABUSHIKI KAISHA, Sakai City (JP)

(72) Inventor: CHIKARA MATSUDA, Sakai City (JP)

(21) Appl. No.: 19/275,234

(22) Filed: Jul. 21, 2025

(30) Foreign Application Priority Data
Jul. 26, 2024 (JP) 2024-121269

(51) Int. Cl. G03G 15/20; G03G 15/00; G03G 21/16

(52) U.S. Cl. CPC G03G 15/2032; G03G 15/2064; G03G 15/502; G03G 15/6594; G03G 15/70; G03G 21/1638; G03G 2215/00514

(57) ABSTRACT

An image forming apparatus includes: a toner image former that forms a toner image on paper based on image information; a fixer that includes at least a pair of rollers and fixes the toner image formed on the paper at a pressure contact portion formed by the pair of rollers; an adjuster that adjusts a pressure contact force in the pressure contact portion according to a paper type; and one or more controllers that control execution of a job related to image formation via the fixer. The one or more controllers provide, to a user, a notification prompting the user to confirm the paper type of the paper being fed in a case where the paper type set for the execution of the job differs from the paper type of the fed paper.

### CROSS-REFERENCE TO RELATED APPLICATION

The present application claims priority from Japanese Application JP2024-121269, the content of which is hereby incorporated by reference into this application.

### BACKGROUND OF THE INVENTION

### 1. Field of the Invention

The disclosure relates to an image forming apparatus and the like.

### 2. Description of the Related Art

Some image forming apparatuses that employ an electrophotographic method, such as printers and multifunction peripherals, fix a toner image by sandwiching paper on which the toner image has been formed in a pressure contact portion (also called a nip portion) of a fixer.

For example, in an image forming apparatus in which the nip pressure of a fixing nip portion can be manually changed, it is known to change the nip pressure according to the type of paper.

### SUMMARY

An object of the disclosure is to provide an image forming apparatus and the like that enable a user to accurately ascertain an adjustment state of a pressure contact force in a pressure contact portion.

In order to solve the above problem, an image forming apparatus according to the disclosure includes: a toner image former that forms a toner image on paper based on image information; a fixer that includes at least a pair of rollers and fixes the toner image formed on the paper at a pressure contact portion formed by the pair of rollers; an adjuster that adjusts a pressure contact force in the pressure contact portion according to a paper type; and one or more controllers that control execution of a job related to image formation via the fixer, in which the one or more controllers provide, to a user, a notification prompting the user to confirm the paper type of the paper being fed in a case where the paper type set for the execution of the job differs from the paper type of the fed paper.

In addition, an image forming apparatus according to the disclosure includes: a toner image former that forms a toner image on paper based on image information; a fixer that includes at least a pair of rollers and fixes the toner image formed on the paper at a pressure contact portion formed by the pair of rollers; an adjuster that adjusts a pressure contact force in the pressure contact portion according to a paper type; and one or more controllers that control execution of a job related to image formation via the fixer, in which, when a notification prompting adjustment of the pressure contact force by the adjuster is provided to a user, the one or more controllers restrict display of a selection button for receiving a selection instruction for instructing to delete the notification until a predetermined condition is satisfied.

In addition, an image forming method according to the disclosure includes: forming a toner image on paper based on image information; fixing the toner image formed on the paper at a pressure contact portion formed by the pair of rollers; adjusting a pressure contact force in the pressure contact portion according to a paper type; and providing, to a user, a notification prompting the user to confirm the paper type of the paper being fed in a case where the paper type set for the execution of the job differs from the paper type of the fed paper.

According to the disclosure, it is possible to provide an image forming apparatus and the like that enable a user to accurately ascertain an adjustment state of a pressure contact force in a pressure contact portion.

### BRIEF DESCRIPTION OF THE DRAWINGS

FIG. 1 is a diagram illustrating an overall configuration of an image forming apparatus according to a first embodiment.

FIG. 2 is a diagram illustrating a configuration of an adjuster according to the first embodiment.

FIG. 3 is a table illustrating operating lever positions according to paper types.

FIG. 4 is a diagram illustrating a functional configuration of the image forming apparatus according to the first embodiment.

FIG. 5 is a flowchart illustrating a process flow according to the first embodiment.

FIG. 6 is a diagram illustrating an operation example according to the first embodiment.

FIG. 7 is a diagram illustrating an operation example according to the first embodiment.

FIG. 8 is a diagram illustrating an operation example according to the first embodiment.

FIG. 9 is a flowchart illustrating a process flow according to a second embodiment.

FIG. 10 is a diagram illustrating an operation example according to the second embodiment.

FIG. 11 is a diagram illustrating a functional configuration of an image forming apparatus according to a third embodiment.

FIG. 12 is a flowchart illustrating a process flow according to the third embodiment.

FIGS. 13A to 13C are diagrams illustrating an operation example according to the third embodiment.

FIG. 14 is a diagram illustrating an operation example according to the third embodiment.

FIGS. 15A to 15D are diagrams illustrating a paper jam clearing guidance.

### DETAILED DESCRIPTION OF THE INVENTION

Hereinafter, embodiments of the disclosure will be described with reference to the drawings. In the disclosure, for example, a multifunction peripheral capable of performing jobs related to copying, faxing, e-mail, and the like in one housing will be described as one form of an image forming apparatus. In the disclosure, a configuration of a fixer will be described, which includes at least a pair of rollers including a pressure roller and a heat roller, and fixes a toner image by sandwiching paper on which the toner image has been formed in a pressure contact portion formed by the pair of rollers; however, it is also possible to configure the pressure contact portion via a pad member via a fixing belt instead of a heat roller. Note that the following embodiments are examples for describing the disclosure, and the technical content of the description described in the claims is not limited to the following description.

In image forming apparatuses that have a mechanism for manually operating pressure contact and pressure release on a roller pair constituting the fixer, but do not have a function of automatically detecting when the pressure is released, in a case where an event occurs that requires a pressure release operation, such as when printing with paper of a paper type having a paper thickness greater than that of plain paper, such as an envelope, or when clearing a paper jam, a notification screen is displayed to a user, requesting the user to perform a pressure release operation, for example.

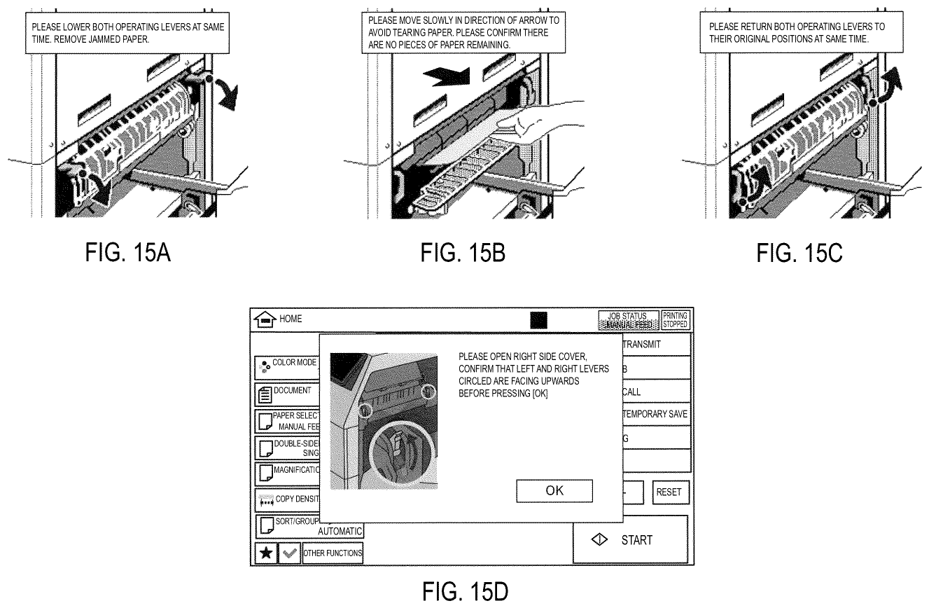

For example, FIGS. 15A to 15D illustrate examples of paper jam clearing guidance that is displayed in a case where a paper jam occurs. Note that FIGS. 15A to 15D illustrate guidance for clearing a paper jam that occurs when executing a print job using plain paper as the paper type, and the operating lever for manually operating pressure contact and pressure release is described as being in the adjustment position for plain paper (upward).

FIG. 15A is a diagram illustrating an operation direction of the operating lever for releasing the pressure contact state of the pressure contact portion. The guidance at this time is “Please lower both operating levers at the same time. Remove the jammed paper.”

FIG. 15B is a diagram illustrating a direction in which jammed paper is removed. The guidance at this time is “Please move slowly in the direction of the arrow to avoid tearing the paper. Please confirm there are no pieces of paper remaining.”

FIG. 15C is a diagram illustrating an operation direction of the operating lever for returning the pressure contact state of the pressure contact portion to its original state after the paper has been removed. The guidance at this time is “Please return both operating levers to their original positions at the same time.”

FIG. 15D is an example of a notification screen that prompts the user to adjust the operating lever to the appropriate operation position based on the paper settings for the interrupted print job after the guidance illustrated in FIGS. 15A to 15C has ended (in a case where the cover member of the apparatus is closed and the paper jam has been cleared).

Here, in the disclosure, a notification screen that displays such a notification is referred to as an operation position confirmation notification screen. For example, in a case where the paper setting for the interrupted print job is plain paper, a notification screen is displayed, prompting the user to adjust the operating lever to the “upward” position to bring the pressure contact portion into the pressure contact state (FIG. 15D). On the other hand, in a case where the paper setting for the interrupted print job is an envelope of a paper type having a paper thickness greater than that of plain paper, a notification screen (not illustrated) is displayed, prompting the user to adjust the operating lever to the “downward” position for releasing the pressure contact state of the pressure contact portion. The operation position confirmation notification screen may be displayed only in a case where the guidance illustrated in FIGS. 15A to 15C displays the content related to the operation of the operating lever. Whether or not to display the operation position confirmation notification screen can be switched by the system settings of the image forming apparatus.

After confirming the notification content on the displayed operation position confirmation notification screen, the user can resume the interrupted print job by selecting an OK button.

However, whether or not the notification content can be displayed is determined based on the paper settings that are set in advance as a print job. Therefore, in a case where the paper settings that are set in advance and the paper type of paper actually fed to the paper feed tray and the like differ, poor image quality, paper jams, and the like may occur even if the user operates the device according to the work content displayed on the operation position confirmation notification screen.

In the disclosure, the following embodiments provide an image forming apparatus and the like that enable a user to accurately ascertain the adjustment state of the pressure contact force in the pressure contact portion.

### 1 First Embodiment

A first embodiment is a form in which, in a case where the paper type set for executing a job differs from the paper type of the paper actually fed, a notification is provided to the user to prompt the user to confirm the paper type of the fed paper.

### 1.1 Overall Configuration

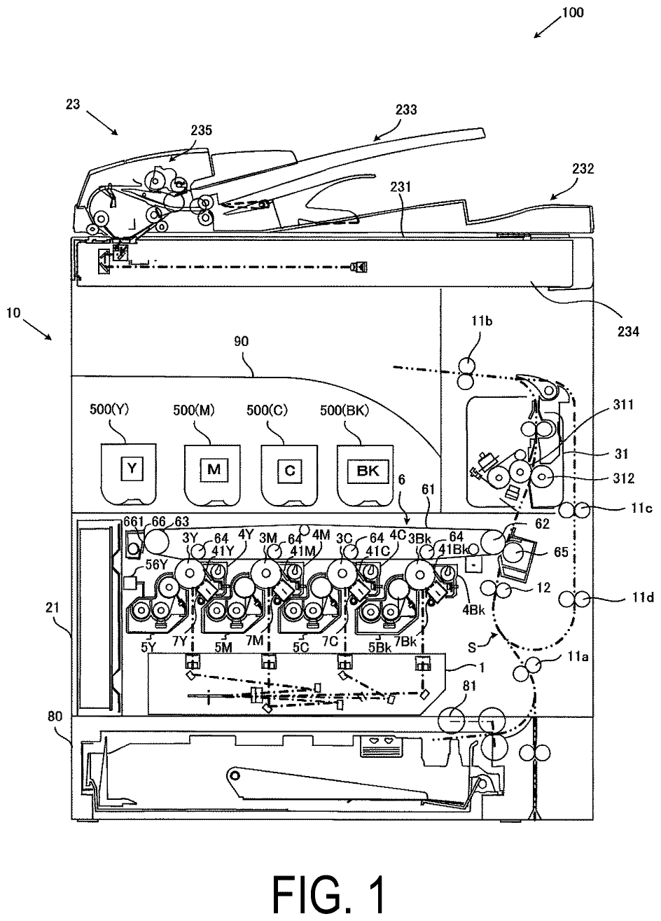

FIG. 1 is a front cross-sectional view illustrating an overall configuration of a multifunction peripheral 100 according to the first embodiment. The multifunction peripheral 100 includes a main body 10 that accommodates various members related to image formation, such as a developing device, and an image inputter 23 that is provided above the main body 10 and is capable of generating image information based on a read document. The multifunction peripheral 100 is an image forming apparatus capable of outputting image information generated by the image inputter 23 as a printed matter.

Inside the main body 10, a toner image former 21 and a fixer 31 are provided along a paper transport path S (indicated by a two-dot chain line in FIG. 1) that starts at a paper feed tray 80 and ends at a paper discharge tray 90.

The paper feed tray 80 is configured as a box-shaped member capable of accommodating a stack of paper, and is detachably mounted on the bottom of the multifunction peripheral 100. A pickup roller 81 is provided above the paper feed tray 80 for picking up the accommodated paper one piece at a time from the top and feeding the paper out to the paper transport path S.

The paper discharge tray 90 is formed by utilizing an outer casing of the main body 10, and accumulates printed paper face-down, with the printed surface facing downward.

The paper transport path S is constituted by a plurality of transport rollers 11a to 11d, a registration roller 12, a transport path switching section (not illustrated), and the like. The transport rollers 11a to 11d are small rollers for facilitating and assisting the transport of paper, and the transport rollers 11a to 11d grip and transport the paper while rotating. The registration roller 12 corrects any skew of the paper on the paper transport path S, and transports the paper to a transfer section 6 (secondary transfer roller 65) at a timing that aligns the leading edge of the toner image formed on a photosensitive drum surface with the leading edge of the paper.

For example, in the case of single-sided printing in the forward direction relative to the paper transport path S, the paper fed from the paper feed tray 80 is transported through the transport roller 11a, the registration roller 12, the transfer section 6 (secondary transfer roller 65), and the fixer 31, and is discharged onto the paper discharge tray 90 by the transport roller 11b. In contrast, in the case of double-sided printing, which includes transport in the opposite direction to the paper transport path S, when the leading edge of the paper reaches the transport roller 11b, the transport path is switched by a transport path switching section (not illustrated), and then the transport roller 11b rotates in the opposite direction to guide the paper to the paper transport path S formed by the transport rollers 11c and 11d. The paper that has passed through the transport roller 11d is transported to the transfer section 6 with the printed surface inverted. The paper on which the toner image has been transferred to the reverse side of the first printed surface in the transfer section 6 passes through the fixer 31 and is then discharged onto the paper discharge tray 90 by the transport roller 11b.

The toner image former 21, which is provided along the paper transport path S, includes an exposure section 1, photosensitive drums 3 (3Y, 3M, 3C, 3Bk) as image carriers, cleaning units 4 (4Y, 4M, 4C, 4Bk), developing sections 5 (5Y, 5M, 5C, 5Bk) as a developing device, the transfer section 6, and charging sections 7 (7Y, 7M, 7C, 7Bk). Here, the image information handled by the multifunction peripheral 100 corresponds to a color image using the colors yellow (Y), magenta (M), cyan (C), and black (Bk). Therefore, the photosensitive drums 3 (3Y, 3M, 3C, 3Bk), the cleaning unit 4, the developing section 5, and the charging section 7 are provided to form four types of electrostatic latent images corresponding to the respective colors. In addition, the configurations of the photosensitive drums 3 (3Y, 3M, 3C, 3Bk), the cleaning units 4 (4Y, 4M, 4C, 4Bk), the developing sections 5 (5Y, 5M, 5C, 5Bk), and the charging sections 7 (7Y, 7M, 7C, 7Bk) can be the same for each toner color. Therefore, unless otherwise specified, the following description will be provided simply referring to the photosensitive drum 3, the cleaning unit 4, the developing section 5, and the charging section 7.

The exposure section 1 exposes a charged photosensitive drum 3 to light in accordance with image information generated by reading externally input image information or a document using the image inputter 23, thereby forming an electrostatic latent image on the surface of the photosensitive drum 3 in accordance with the image information. Such an exposure section 1 can be configured, for example, as a light-emitting diode (LED) unit having a light-emitting element such as an LED element and a lens array, or as a laser scan unit having a laser emission unit, a reflecting mirror, and the like. The exposure section 1 is disposed at a position where irradiation light (indicated by a one-dot chain line in FIG. 1) based on image information forms an image on the surface of the photosensitive drum 3. The exposure section 1 exposes the surface of the photosensitive drum 3, which is charged to −600 V, to light, thereby setting the exposed portion (electrostatic latent image portion) to the charge voltage of −150 V.

The photosensitive drum 3 is an image carrier that forms an electrostatic latent image in accordance with image information of each toner color. The photosensitive drum 3 can be formed, for example, as a cylindrical image carrier in which a photosensitive layer is formed on the surface of a conductive support. The photosensitive drum 3 is configured to be rotatable about the axis of the conductive support by a driving force supplied from a driving source (for example, a motor) (not illustrated). The photosensitive layer may be made of a material that exhibits conductivity by receiving light, such as amorphous silicon, selenium, a selenium alloy, cadmium sulfide, zinc oxide, or an organic optical semiconductor. As the image carrier, an endless photosensitive belt may be used instead of the photosensitive drum.

The cleaning unit 4 is a cleaning unit that collects transfer residual toner remaining on the surface of the photosensitive drum 3 after development and transfer. The cleaning unit 4 includes a cleaning blade 41 facing the photosensitive drum 3. The cleaning blade 41 scrapes off the transfer residual toner on the surface of the photosensitive drum 3 to collect the transfer residual toner.

The developing section 5 develops the electrostatic latent image formed on each photosensitive drum 3 with toner of four colors, yellow (Y), magenta (M), cyan (C), and black (Bk), to form a toner image. The developing section 5 develops the electrostatic latent image formed on the surface of the photosensitive drum 3 into a toner image using toner of each color supplied from toner cartridges 500 (500(Y), 500(M), 500(C), 500(Bk)) mounted above the toner image former 21.

The transfer section 6 transfers the toner image formed on the surface of the photosensitive drum 3 onto paper. The transfer section 6 includes an endless intermediate transfer belt 61, an intermediate transfer belt drive roller 62, an intermediate transfer belt driven roller 63, a primary transfer roller 64, a secondary transfer roller 65, and an intermediate transfer belt cleaning unit 66.

The intermediate transfer belt 61 is stretched between the intermediate transfer belt drive roller 62 that rotates by a driving force supplied from a driving source (not illustrated) and the intermediate transfer belt driven roller 63 that is driven to rotate by the driving of the intermediate transfer belt 61. The primary transfer roller 64 is provided at a position facing each photosensitive drum 3 with the intermediate transfer belt 61 interposed therebetween. A primary transfer bias is applied to the primary transfer roller 64 for transferring the toner image formed on the surface of the photosensitive drum 3 onto the intermediate transfer belt 61. The intermediate transfer belt 61 is driven in the direction from the photosensitive drum (3Y) for yellow to the photosensitive drum (3Bk) for black, and sequentially performs primary transfer of toner images corresponding to the respective toner colors.

The secondary transfer roller 65 is provided to be in pressure contact with the intermediate transfer belt drive roller 62 via the intermediate transfer belt 61. A secondary transfer bias is applied to the secondary transfer roller 65 for secondarily transferring the toner image, which has been primarily transferred onto the intermediate transfer belt 61, onto the paper transported along the paper transport path S.

The intermediate transfer belt cleaning unit 66 is a cleaning unit that collects transfer residual toner remaining on the intermediate transfer belt 61. The intermediate transfer belt cleaning unit 66 includes a belt cleaning blade 661 that comes into contact with the intermediate transfer belt 61 with a predetermined pressure. The belt cleaning blade 661 scrapes off the transfer residual toner remaining on the intermediate transfer belt 61 to collect the transfer residual toner. The charging section 7 charges the surface of the photosensitive drum 3 to a predetermined potential. As the charging section 7, for example, a corona discharge device, a brush-type charging device, a roller-type charging device, an ion generating device, or the like can be used.

The fixer 31 includes a heat roller 311 and a pressure roller 312. The fixer 31 is provided downstream of the secondary transfer position formed by the secondary transfer roller 65 and the intermediate transfer belt drive roller 62 in the paper transport path. The heat roller 311 has a built-in heating element (not illustrated), such as a ceramic heater, and the temperature of the pressure contact portion formed by the heat roller 311 and the pressure roller 312 is controlled to a predetermined fixing temperature. The paper onto which the toner image has been transferred is gripped and transported through the pressure contact portion formed by the heat roller 311 and the pressure roller 312, which are maintained at a predetermined fixing temperature, thereby applying heat and pressure and thermally fixing the toner image on the paper.

The fixer 31 according to the disclosure is configured such that a user can adjust the pressure contact force in the pressure contact portion formed by the heat roller 311 and the pressure roller 312 to either a first pressure contact force or a second pressure contact force weaker than the first pressure contact force by operating an adjuster 33 to be described later.

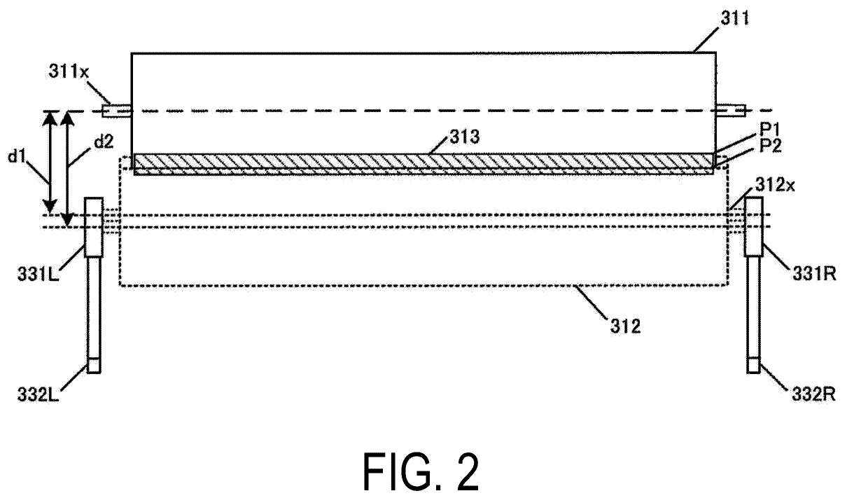

Here, the configuration of the adjuster 33 according to the disclosure will be described. The adjuster 33 adjusts the pressure contact force in the pressure contact portion formed by the heat roller 311 and the pressure roller 312 to either a first pressure contact force or a second pressure contact force weaker than the first pressure contact force. FIG. 2 is a diagram schematically illustrating the schematic arrangement (contact) relationship between the heat roller 311 and the pressure roller 312. The heat roller 311 and the pressure roller 312 constitute a pair of rollers, and the roller surfaces of the two rollers come into contact with each other with a predetermined pressure contact force, thereby forming a pressure contact portion 313.

The adjuster 33 includes adjustment mechanism portions 331R and 331L that change an inter-axis distance d between a shaft 311x of the heat roller 311 and a shaft 312x of the pressure roller 312, and operating lever portions 332R and 332L as adjustment members. The adjustment mechanism portions 331R and 331L include an inter-axis distance adjustment mechanism (not illustrated) made up of, for example, an elastic member such as a spring, a cam, a linkage, and the like, and are provided on both the left and right ends of the shaft 312x of the pressure roller 312. The adjustment mechanism portions 331R and 331L are connected to operating lever portions 332R and 332L, respectively. The operating lever portions 332R and 332L are configured to be rotatable about a rotation base point (not illustrated) when operated in the upward or downward direction by a user. The adjuster 33 according to the disclosure adjusts the inter-axis distance d between the heat roller 311 and the pressure roller 312 to either d1 (contact position P1) or d2 (contact position P2) by the user operating the operating lever portions 332R and 332L. In the disclosure, the pressure contact force of the pressure contact portion 313 at the contact position P1 is referred to as a first pressure contact force, and the pressure contact force of the pressure contact portion 313 at the contact position P2 is referred to as a second pressure contact force. The second pressure contact force at the contact position P2 is weaker than the first pressure contact force because the inter-axis distance d2 is longer than the inter-axis distance d1 at the contact position P1. In the following description, the lever position of the operating lever portions 332R and 332L at the contact position P1 (first pressure contact force) may be referred to as a pressure contact position (simply upward), and the lever position of the operating lever portions 332R and 332L at the contact position P2 (second pressure contact force) may be referred to as a pressure release position (simply downward). Furthermore, the operating lever portions 332R and 332L may be simply referred to as an operating lever portion 332 when there is no need to distinguish between left and right.

In the disclosure, the operating lever portion 332 has been illustrated as one form of the adjustment mechanism of the adjuster 33, but the adjuster 33 can also be configured to electrically switch the inter-axis distance d using an operation button or the like.

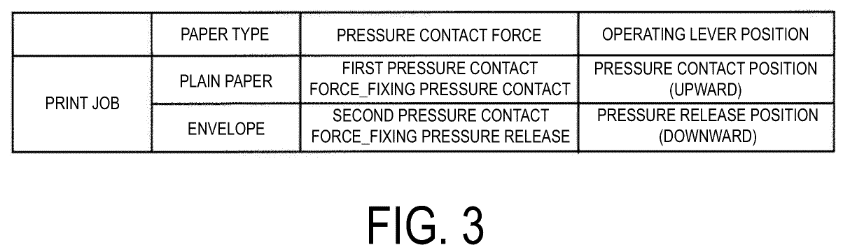

FIG. 3 is a diagram summarizing a relationship between a paper type, a pressure contact force in a pressure contact portion, and an operating lever position in a print job according to the disclosure. As illustrated in FIG. 3, in a case where the print job uses the paper type “plain paper,” the pressure contact force is “first pressure contact force_fixing pressure contact,” and the operating lever position is “pressure contact position (upward).” On the other hand, in a case where the print job uses the paper type “envelope,” the pressure contact force is “second pressure contact force_fixing pressure release,” and the operating lever position is “pressure release position (downward).”

In addition, in FIG. 3, the paper types are described as “plain paper” and “envelope” as examples, but the paper type may be defined as “first thickness” or “second thickness” depending on the thickness of the paper. In this case, the paper belonging to the “first thickness” is “plain paper,” and an example of the paper belonging to the “second thickness” is an “envelope.” In this case, the paper belonging to the “second thickness” may be, for example, a postcard, a business card, or thick paper.

Referring back to FIG. 1, the image inputter 23 provided above the main body 10 includes a document table 231 having a transparent material such as transparent glass. A document pressing cover 232 that can be opened and closed via a hinge or the like (not illustrated) is provided above the document table 231. A document feed tray 233 is attached to the upper part of the document pressing cover 232, and an automatic document feeder 235 is provided inside the document feed tray 233 to transport a document placed on the document feed tray 233 to a document reading section 234.

The document reading section 234 includes a light source, a plurality of reflecting mirrors, an imaging lens, a line sensor having a light receiving element, and the like. The document reading section 234 focuses reflected light, which is light emitted from a light source and reflected by a reading surface of a document, onto an imaging lens by using a plurality of reflecting mirrors. The reflected light focused by the imaging lens forms an image on the light receiving elements of the line sensor. The line sensor detects the luminance and chromaticity of the reflected light that is focused on the light receiving element, and generates image data (image information) based on the image of the reading surface of the document. As the line sensor, for example, a charge coupled device (CCD), a contact image sensor (CIS), or the like can be used.

### 1.2 Functional Configuration

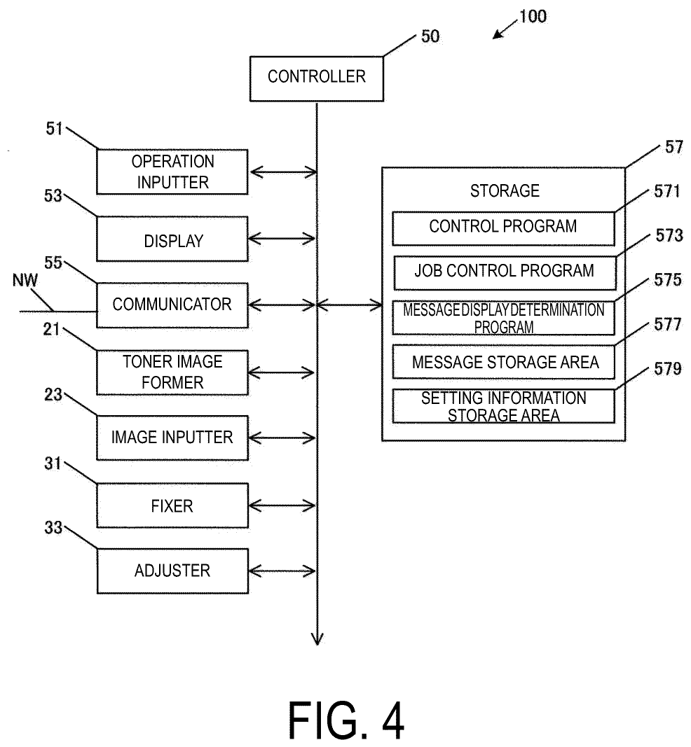

Next, the functional configuration of the multifunction peripheral 100 will be described with reference to FIG. 4. The description of the configuration already described with reference to FIGS. 1 and 2 will be omitted. The multifunction peripheral 100 includes a controller 50, an operation inputter 51, a display 53, a communicator 55, a toner image former 21, an image inputter 23, a fixer 31, an adjuster 33, and a storage 57.

The controller 50 integrally controls the multifunction peripheral 100. The controller 50 can be configured with one or more processing devices (for example, a central processing unit (CPU), a system on chip (SoC), or the like). The controller 50 realizes its functions by reading and executing various programs stored in the storage 57.

The operation inputter 51 is an input device that receives information input by a user or the like. The operation inputter 51 can be configured with various input devices such as operation keys, such as hard keys or software keys, and buttons. The operation inputter 51 can also be configured as a touch panel that allows an input via the display 53 such as a liquid crystal display (LCD) or an organic electro-luminescence (EL) display. In a case where the operation inputter 51 is configured as a touch panel, it is possible to acquire coordinate information, pressure sensitive information, and the like on the touch panel. In this case, as the input method of the touch panel, a common method such as a resistive film method, an infrared method, an electromagnetic induction method, or a capacitive method can be employed.

The display 53 is a display device that displays various types of information to the user. The display 53 can be configured with a display device such as a liquid crystal display (LCD) or an organic electro-luminescence (EL) display.

The communicator 55 includes a wired/wireless interface or both for communicating with other devices (not illustrated) via a network NW such as a local area network (LAN), a wide area network (WAN), the Internet, a telephone line, or a FAX line. The communicator 55 may also include an interface for (short-range) wireless communication technology such as Bluetooth (registered trademark), near field communication (NFC), Wi-Fi (registered trademark), ZigBee (registered trademark), infrared data association (IrDA), and a wireless universal serial bus (USB).

In addition to the configuration described with reference to FIG. 1, the image inputter 23 can also be configured as an interface capable of acquiring image information stored in a storage medium such as a USB memory, or image information transmitted from an external device (not illustrated).

The storage 57 is one or more storage devices that store various programs and various types of data required for the operation of the multifunction peripheral 100. The storage 57 can be configured with a storage device such as a random access memory (RAM), a solid state drive (SSD), a hard disk drive (HDD), and a read only memory (ROM).

In the first embodiment, the storage 57 stores a control program 571, a job control program 573, and a message display determination program 575, and reserves a message storage area 577 and a setting information storage area 579.

The control program 571 is a program that is read by the controller 50 when the controller 50 integrally controls the multifunction peripheral 100. The controller 50 that has read the control program 571 controls the driving of hardware such as the operation inputter 51, the display 53, the communicator 55, the toner image former 21, the image inputter 23, the fixer 31, and the adjuster 33.

The job control program 573 is a program that is read by the controller 50 when executing each job such as printing, copying, faxing, and transmitting an e-mail. The controller 50 that has read the job control program 573 transitions to a job mode (a print mode, a copy mode, a fax mode, an e-mail transmission mode) for executing each job, and executes the job. When executing a job, the controller 50 displays, as necessary, a job execution screen that receives selection of setting values and functions required to execute the job from the user, and a notification screen that notifies the user of a message, on a touch panel configured as the operation inputter 51 (display 53). The controller 50 can execute a job based on the setting values and functions received via the execution screen of the job.

The message display determination program 575 is a program that the controller 50 reads when determining whether the print job is to be executed via the fixer 31 adjusted to the first pressure contact force or the second pressure contact force. Furthermore, the controller 50 that has read the message display determination program 575 notifies the user of the content, prompting the user to operate the operating lever portion 332 (operation position confirmation notification) in accordance with the result of the above determination.

Furthermore, in a case where the paper type set for executing the print job differs from the paper type of the paper actually fed to the paper feed tray, the controller 50 that has read the message display determination program 575 provides, to the user, a notification prompting the user to confirm the paper type of the fed paper (paper type confirmation notification). In this case, the controller 50 can determine the paper type by comparing the paper type detection result by an optical or mechanical detector (not illustrated) with the paper type set for executing the print job.

The message storage area 577 is a storage area that stores at least notification (message) information notified by the controller 50 that has read the message display determination program 575.

The setting information storage area 579 is a storage area that stores various setting values, functions, and the like received via the execution screen of the job. For example, in a case where the job to be executed is a print job, the setting information storage area 579 stores, as setting values, the paper type, designation information of the paper feed tray that accommodates the paper to be printed, and the like.

### 1.3 Process Flow

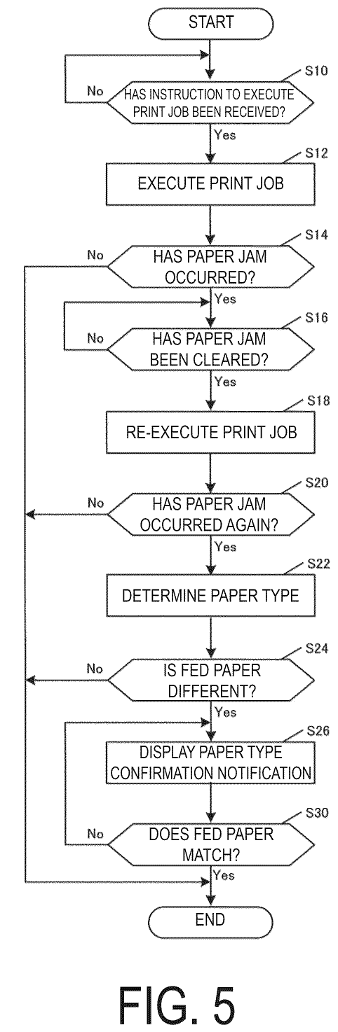

Next, a process flow according to the first embodiment will be described with reference to a flowchart illustrated in FIG. 5. The process described with reference to FIG. 5 is executed by the controller 50 of the multifunction peripheral 100 by reading the control program 571, the job control program 573, the message display determination program 575, and the like.

However, even in a case where a print job is executed with the paper type set to “plain paper,” if the paper type of the paper actually fed is “envelope,” a paper jam will occur because the operating lever is not in the position (downward) appropriate for printing on an envelope. Even if the user operates the operating lever portion 332 according to the notification content on the operation position confirmation notification screen after clearing the paper jam, the “plain paper” setting is applied in the print job settings, and the user is prompted to set the operating lever portion 332 in the upward position, which will result in a paper jam occurring again. In consideration of this situation, the flowchart in FIG. 5 describes a form in which paper type determination is performed in a case where a paper jam occurs again, but it is, of course, also possible to perform paper type determination in a case where a paper jam occurs for the first time.

When the process starts, the controller 50 receives an input of setting values such as paper type related to the execution of the print job via the job execution screen or the like, and then determines whether or not an instruction to execute the print job has been received (step S10). In a case where it is determined that an instruction to execute a print job has been received, the controller 50 executes the print job (step S10; Yes→step S12). In a case where it is determined that the instruction to execute the print job has not been received, the controller 50 waits until the instruction to execute the print job is received (step S10; No).

When executing a print job, the controller 50 determines whether or not a paper jam has occurred (step S14). In a case where it is determined that a paper jam has not occurred, the controller 50 ends the process (step S14; No→End).

In a case where it is determined that a paper jam has occurred, the controller 50 determines whether or not the paper jam has been cleared by the user according to the paper jam clearing guidance illustrated in FIGS. 15A to 15D (step S14; Yes→step S16). In a case where it is determined that the paper jam has been cleared, the controller 50 re-executes the print job (step S16; Yes→step S18). In a case where it is determined that the paper jam has not been cleared, the controller 50 waits until the paper jam is cleared (step S16; No).

After re-executing the print job, the controller 50 determines whether or not a paper jam has occurred again (step S20). In a case where it is determined that a paper jam has occurred again, the controller 50 determines the paper type by comparing the paper type of the paper fed to the paper feed tray with the paper type related to the execution of the print job received in step S10 (step S20; Yes→step S22). In a case where it is determined that the paper jam has not occurred again, the controller 50 ends the process (step S20; No→End).

In a case where it is determined as a result of the paper type determination that the paper type of the paper fed to the paper feed tray is different from the paper type used to execute the print job, the controller 50 displays a notification screen (paper type confirmation notification screen) that prompts the user to confirm the paper type of the fed paper (step S24; Yes→step S26). On the other hand, in a case where it is determined that the paper type of the paper fed to the paper feed tray is the same as the paper type related to the execution of the print job, the controller 50 ends the process (step S24; No→End). In this case, since it can be determined that the reoccurrence of the paper jam is not due to a mismatch in paper type, the controller 50 may be configured to notify the user of other factors (for example, the jammed paper has not been completely removed).

After displaying the paper type confirmation notification, the controller 50 determines whether or not the paper type of the fed paper matches the paper type related to the execution of the print job (step S30). In a case where the paper type of the fed paper matches the paper type related to the execution of the print job, the controller 50 re-executes the print job and ends the process (step S30; Yes→End). On the other hand, in a case where it is determined that the paper type of the fed paper does not match the paper type related to the execution of the print job, the controller 50 continues to display the paper type confirmation notification screen (step S30; No→step S26).

### 1.4 Operation Example

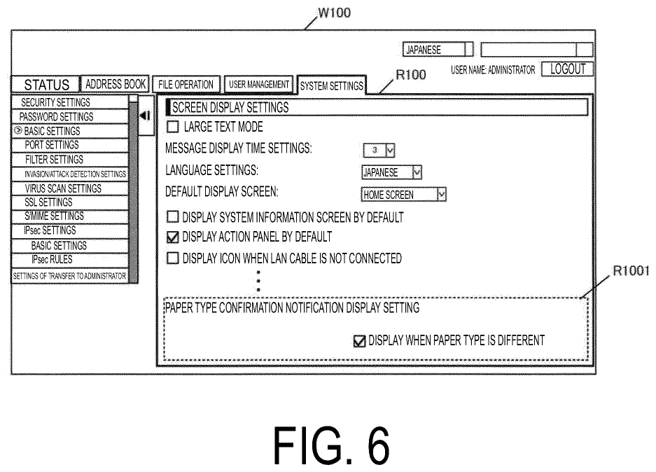

Next, an operation example according to the first embodiment will be described. FIG. 6 is a diagram illustrating an example of a configuration of a system setting screen W100 according to the first embodiment.

The system setting screen W100 includes a system setting area R100. The system setting area R100 includes a setting area R1001 that receives settings related to the display of the paper type confirmation notification. In a case where the user desires to display the paper type confirmation notification screen, the user can display the paper type confirmation notification screen by checking the “display when paper type is different” checkbox.

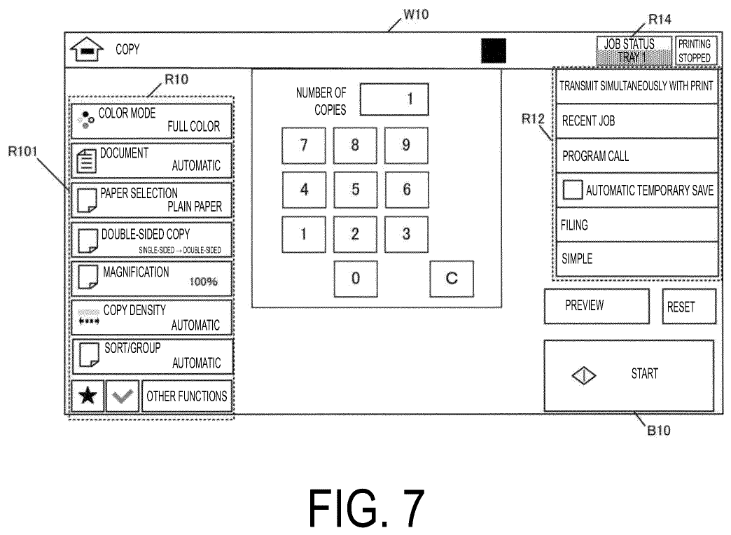

FIG. 7 is a diagram illustrating an example of a configuration of a job execution screen W10 that receives an instruction to execute a print job. The job execution screen W10 can be displayed based on a call instruction via, for example, a home screen (not illustrated). The job execution screen W10 for a print job includes a setting value display area R10, a function selection area R12, a job status display area R14, and a start button B10.

The setting value display area R10 is a display area that displays setting items related to the execution of a print job and setting values of the setting items. FIG. 7 illustrates an example in which setting values relating to “color mode,” “document,” “paper selection R101,” “double-sided copy,” “magnification,” “copy density,” “sort/group,” and the like are displayed as setting values displayed in the setting value display area R10. The setting values displayed in the setting value display area R10 can be changed by the user as appropriate.

The function selection area R12 is a display area that displays function selection keys that receive the selection of functions that can be set when executing a print job. FIG. 7 illustrates an example in which a “transmit simultaneously with print” key, a “recent job” key, a “program call” key, a “automatic temporary save” key, a “filing” key, and a “simple” key that receives screen transition to a simple execution screen, and the like are displayed as function selection keys.

The job status display area R14 is a display area that displays the execution status of a job while the job is being executed. In the job status display area R14, for example, as illustrated in FIG. 7, additional information related to the execution of the job (such as tray information “Tray 1” used to feed plain paper) can be displayed.

The start button B10 is a button for receiving an instruction to execute a job. When the user selects the start button B10, the controller 50 starts executing the print job.

Incidentally, the job execution screen W10 illustrated in FIG. 7 shows a state in which “plain paper” has been selected by the user as the paper type via the paper selection R101 in the setting value display area R10. In a case where the controller 50 determines in step S20 of FIG. 5 that a paper jam has occurred again, the controller 50 determines whether or not to display a paper type confirmation notification by comparing the paper type set by the user via the paper selection R101 with the paper type actually fed to the paper feed tray (for example, “Tray 1”).

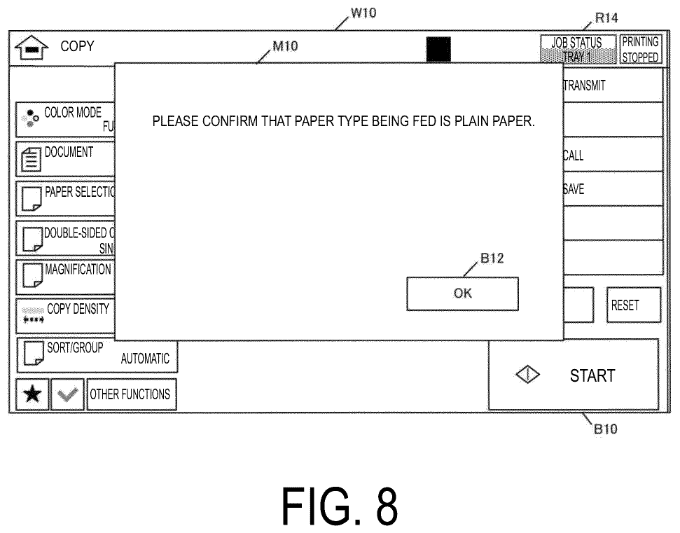

For example, FIG. 8 illustrates an example of the configuration of the paper type confirmation notification screen M10 that the controller 50 displays in a case where the paper actually fed to “Tray 1” is a paper type (envelope or the like) other than plain paper.

The paper type confirmation notification screen M10 includes a notification prompting the user to confirm the paper type of the paper fed to the paper feed tray “Tray 1” (please confirm that the paper type being fed is plain paper) and an OK button B12.

By confirming the paper type of the paper fed to the paper feed tray “Tray 1” based on the notification content on the paper type confirmation notification screen M10, the user can ascertain the difference between the paper type of the paper fed to the paper feed tray by himself/herself or another person and the paper type of the paper set as the print job.

The OK button B12 is a button for receiving a confirmation instruction from the user who has confirmed the notification content on the paper type confirmation notification screen M10. When paper of a type matching the paper type of the paper set as the print job is fed to the paper feed tray and the controller 50 receives a selection instruction of the OK button B12, the controller 50 resumes the print job for the fed paper.

As described above, according to the first embodiment, in a case where the paper type set for executing a job differs from the paper type of the paper actually fed, a notification screen can be displayed, prompting the user to confirm the paper type of the fed paper. Therefore, the user can easily ascertain the difference between the paper type of the paper fed to the paper feed tray by himself/herself or another person and the paper type of the paper set as the print job.

### 2 Second Embodiment

A second embodiment is a form in which, in a case where paper of a paper type such as an envelope is placed in a paper feed tray such as a manual feed tray, the user is prompted to confirm the operation position of the operating lever portion 332 appropriate for that paper type.

### 2.1 Functional Configuration

A functional configuration of a multifunction peripheral according to the second embodiment can be the same as that of the multifunction peripheral 100 according to the first embodiment, and therefore, a description thereof will be omitted here. In the second embodiment, an optical or mechanical detector (not illustrated) capable of detecting the paper type may be provided as necessary.

### 2.2 Process Flow

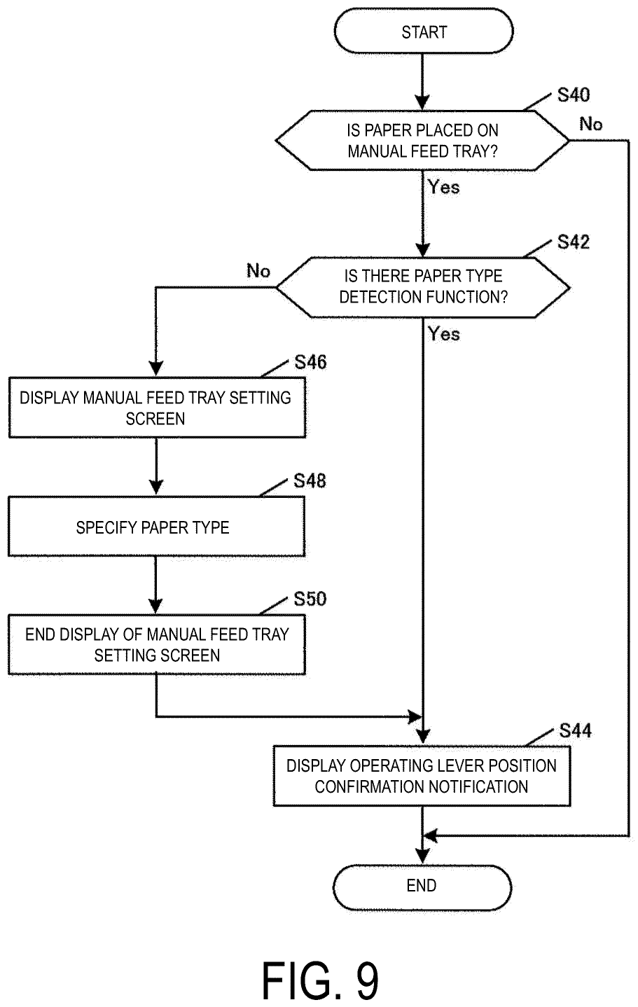

The process flow according to the second embodiment will be described with reference to the flowchart of FIG. 9. The process described with reference to FIG. 9 is executed by the controller 50 of the multifunction peripheral 100 by reading the control program 571, the job control program 573, the message display determination program 575, and the like.

The controller 50 determines whether or not paper is placed on a paper feed tray, for example, a manual feed tray (step S40). In a case where it is determined that paper is placed on the manual feed tray, the controller 50 branches the process depending on whether or not a paper type detection function is implemented (step S40; Yes→step S42).

In a case where the paper type detection function is implemented, the controller 50 uses the paper type detection function to determine the paper type of the paper placed on the manual feed tray. Then, based on the determined paper type, the controller 50 displays a notification screen (operating lever position confirmation notification screen) that prompts the user to confirm whether or not the operating lever portion 332 is located in an operation position appropriate for that paper type, and ends the process (step S42; Yes→step S44).

On the other hand, in a case where the paper type detection function is not implemented, the controller 50 displays a manual feed tray setting screen (not illustrated) (step S42; No→step S46). Next, the controller 50 specifies the paper type of the paper placed on the manual feed tray based on the paper type setting received from the user via the manual feed tray setting screen (step S48).

When the paper type of the paper placed on the manual feed tray is specified, the controller 50 ends the display of the manual feed tray setting screen, and based on the paper type specified in step S48, the controller 50 displays an operating lever position confirmation notification screen that prompts the user to confirm whether or not the operating lever portion 332 is located in an operation position appropriate for that paper type, and ends the process (step S50→step S44).

Incidentally, in a case where it is determined that no paper is placed on the manual feed tray, the controller 50 ends the process (step S40; No).

### 2.3 Operation Example

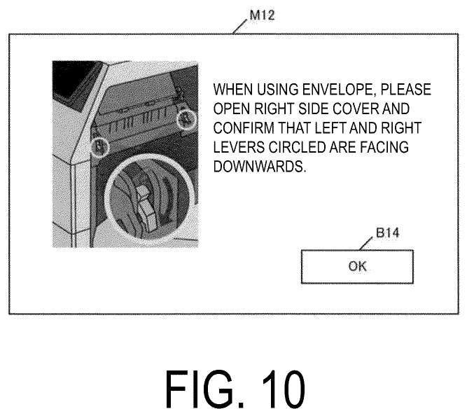

FIG. 10 is a diagram illustrating an example of a configuration of an operating lever position confirmation notification screen M12 according to the second embodiment. The operating lever position confirmation notification screen M12 includes a notification that, in a case where the paper type of the paper placed on the manual feed tray is an envelope, prompts the user to confirm whether or not the operating lever portion 332 is located in an operation position (downward) appropriate for the paper type of the envelope (when using an envelope, please open the right side cover and confirm that the left and right levers circled are facing downward), and an OK button B14.

By confirming the operation position of the operating lever portion 332 based on the notification content on the operating lever position confirmation notification screen M12, the user can ascertain whether or not the pressure contact state in the pressure contact portion is set to an appropriate operation position according to the paper type.

The OK button B14 is a button for receiving a confirmation instruction from the user who has confirmed the notification content on the operating lever position confirmation notification screen M12. When a selection instruction for the OK button B14 is received, the controller 50 can display a job execution screen for executing a print job using paper (envelope) placed on the manual feed tray, for example, and receive an instruction to execute the print job.

Incidentally, in the second embodiment, a manual feed tray has been described as an example of a paper feed tray related to the notification on the operating lever position confirmation notification screen M12. However, the paper feed tray is not limited to a manual feed tray, and may be an automatic paper feed tray that automatically feeds paper placed thereon into the multifunction peripheral 100.

As described above, according to the second embodiment, in a case where paper of a paper type such as an envelope is placed in a paper feed tray such as a manual feed tray, the user can easily confirm the operation position of the operating lever portion that is appropriate for that paper type, and as a result, a printed matter can be obtained in which the fixing process has been executed with settings according to the paper type.

### 3 Third Embodiment

For example, as illustrated in FIG. 15D, in a case where the paper setting for the print job is plain paper, a notification screen (operation position confirmation notification screen) is displayed to the user, prompting the user to set the operating lever portion 332 to the appropriate operation position (“upward”).

In this case, when the user does not perform the appropriate operation, the operating lever portion 332 will not be located in the appropriate operation position. However, even when the user does not perform the operation in accordance with the notification content, in a case where the user selects the selection button (OK button) for receiving the selection instruction for instructing to delete the notification screen, the print job will be executed, which is a problem.

A third embodiment is a form in which, when a notification is provided to the user to prompt the user to operate the operating lever to an operating lever position appropriate for the paper type, the display of a selection button for receiving a selection instruction for instructing to delete the notification is restricted until a predetermined condition is satisfied, thereby making it possible to continuously notify the user of the notification content.

### 3.1 Functional Configuration

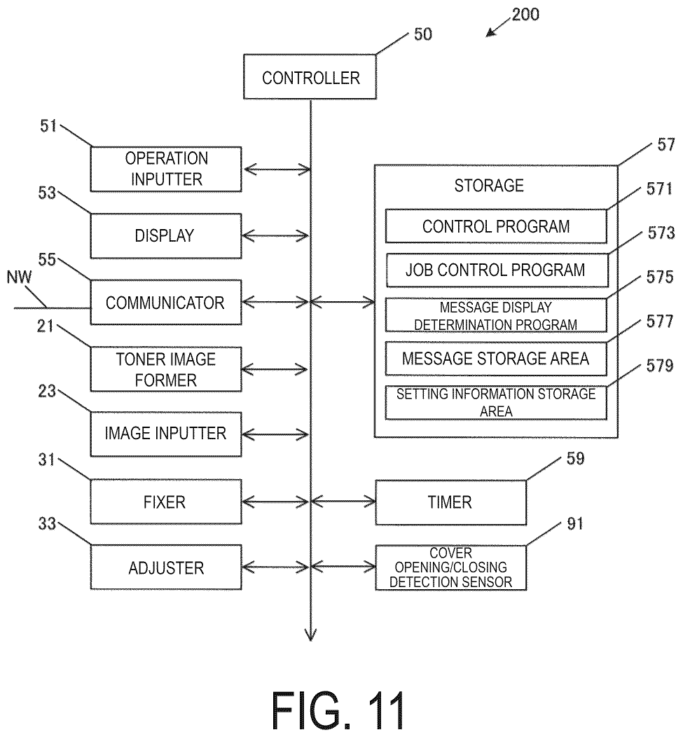

FIG. 11 is a diagram illustrating a functional configuration of a multifunction peripheral 200 according to the third embodiment. The functional configuration of the multifunction peripheral 200 according to the third embodiment can be substantially the same as that of the multifunction peripheral 100 according to the first embodiment, and therefore, the same components are provided the same reference numerals and the description thereof will be omitted.

A timer 59 is a timing member that measures the elapsed time from the start of displaying the operation position confirmation notification screen. A cover opening/closing detection sensor 91 is an optical or mechanical detection member that detects the opening and closing operation of a cover member provided on the housing of the multifunction peripheral 200.

### 3.2 Process Flow

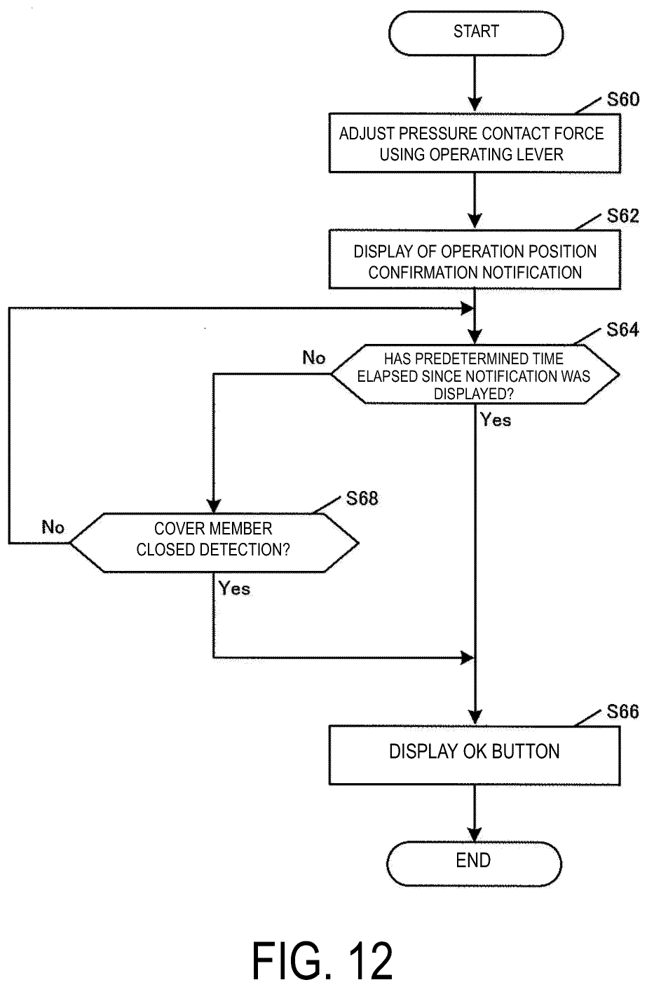

The process flow according to the third embodiment will be described with reference to the flowchart of FIG. 12. The process described with reference to FIG. 12 is executed by the controller 50 of the multifunction peripheral 200 by reading the control program 571, the job control program 573, the message display determination program 575, and the like.

When the user adjusts the pressure contact force using the operating lever, the controller 50 displays an operation position confirmation notification screen (step S60→step S62). At this time, an OK button for receiving a confirmation instruction from the user and an instruction for instructing to delete the operation position confirmation notification screen is not displayed.

The controller 50 determines, using the timer 59, whether or not a predetermined time has elapsed since the start of displaying the operation position confirmation notification screen (step S64). In a case where it is determined that a predetermined time has elapsed since the start of displaying the operation position confirmation notification screen, the controller 50 displays an OK button on the operation position confirmation notification screen, and ends the process (step S64; Yes→step S66).

In a case where it is determined that a predetermined time has not elapsed since the start of displaying the operation position confirmation notification screen, the controller 50 determines whether or not the cover member is closed based on the detection result by the cover opening/closing detection sensor 91 (step S64; No→step S68).

In a case where it is determined that the cover member is closed, the controller 50 displays an OK button on the operation position confirmation notification screen, and ends the process (step S68; Yes→step S66). On the other hand, in a case where it is determined that the cover member is not closed, the controller 50 returns the process to step S64 (step S68; No→step S64).

### 3.3 Operation Example

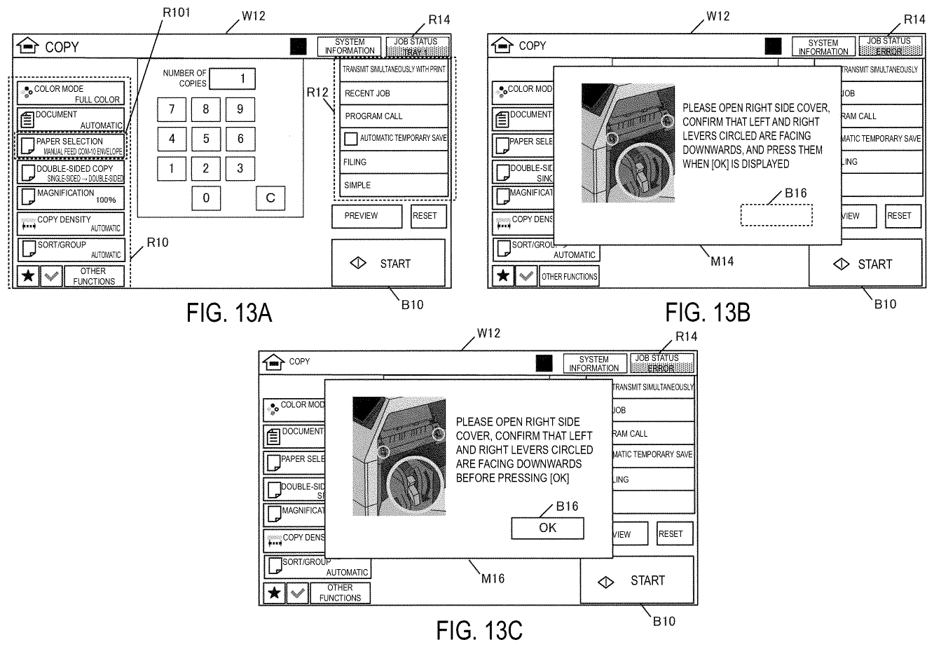

Next, an operation example according to the third embodiment will be described. FIGS. 13A to 13C are diagrams illustrating an example of an operation from when the user adjusts the pressure contact force using the operating lever portion 332 until the OK button is displayed.

FIG. 13A is a diagram illustrating an example of a configuration of a job execution screen W12 for receiving an instruction to execute a print job, and is the same as the job execution screen W10 illustrated in FIG. 7. The job execution screen W12 illustrated in FIG. 13A shows a state in which the paper selection R101 in the setting value display area R10 has been changed from “plain paper” to “envelope.”

FIG. 13B illustrates an example of a configuration of an operation position confirmation notification screen M14 that is displayed in response to a change in the paper type in the paper selection R101. The user can confirm the operation position of the operating lever portion 332 corresponding to the paper type by confirming the notification content on the operation position confirmation notification screen M14. At this time, the operation position confirmation notification screen M14 does not display a selection button (OK button B16) for receiving a selection instruction for instructing to delete the notification screen.

FIG. 13C is an example of a configuration of an operation position confirmation notification screen M16 on which an OK button B16 is displayed after a predetermined time has elapsed since the start of displaying the operation position confirmation notification screen M14 or in a case where the cover member is closed. When the OK button B16 is displayed on the operation position confirmation notification screen M16, the user can select the OK button B16, and after confirming the notification content, can input an instruction to delete the operation position confirmation notification screen M14 (M16). The operation position confirmation notification screen M14 may be configured to be automatically deleted at the timing when the cover member is closed.

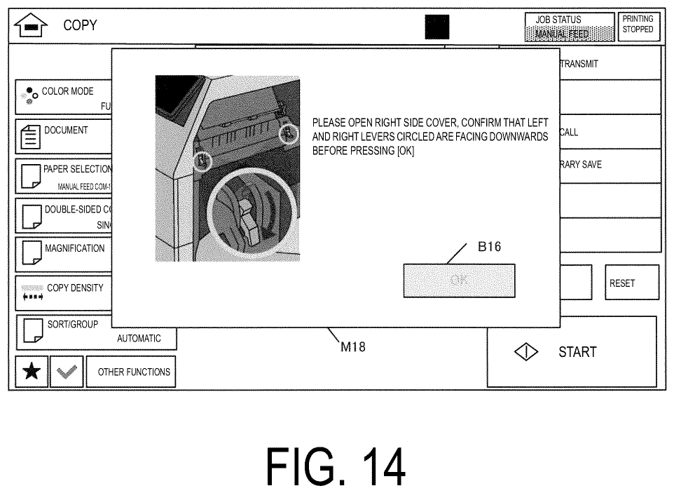

As illustrated by an operation position confirmation notification screen M18 in FIG. 14, the OK button B16 can be displayed in an inactive state when the operation position confirmation notification screen M18 is initially displayed, and can be made active and selectable by the user after a predetermined time has elapsed since the start of display or in a case where the cover member is closed.

Incidentally, in the embodiment, even in a case where a plurality of jobs are registered, the paper type is confirmed at the end of each job, and if the paper type is switched between an envelope and a non-envelope, printing is stopped and the operation position confirmation notification screen M14 (M16) is displayed. Furthermore, regardless of the job type, such as copy, print, or fax printing, if the paper type is switched between an envelope and a non-envelope, the notification screen may be displayed. Furthermore, even if the power is turned off or the printer is switched to energy saving mode between the previous printing and the current printing, the notification screen may be displayed if the paper type is switched between an envelope and a non-envelope.

In the embodiment, it is possible to set whether or not the operation position confirmation notification screen M14 (M16) is displayed via the system setting screen W100 illustrated in FIG. 6. In this case, for example, a “fixing pressure release lever position confirmation message display setting” may be provided, and options such as “display when switching between envelope and non-envelope printing” may be displayed selectably using a check box or the like.

As described above, according to the third embodiment, when a notification is provided to the user to prompt the user to operate the operating lever to an operating lever position appropriate for the paper type, the display of a selection button for receiving a selection instruction for instructing to delete the notification is restricted until a predetermined condition is satisfied, thereby making it possible to continuously notify the user of the notification content.

The disclosure is not limited to the above-described embodiments, and various modifications are possible. In other words, the technical scope of the disclosure also includes embodiments obtained by combining technical means that are appropriately modified within the scope of the gist of the disclosure.

Further, although the above-described embodiments are described separately for convenience of description, it is obvious that the embodiments may be executed in combination within a technically possible scope.

Further, in the embodiments, a program operating on each device is a program that controls a CPU or the like (a program for causing a computer to function) to realize the functions of the above-described embodiments. Information handled by such a device is temporarily stored in a temporary storage device (for example, a RAM) during processing and then stored in various storage devices such as read only memories (ROMs) and HDDs, and is read, modified, and written by the CPU as necessary.

Here, a computer-readable non-transitory recording medium on which the program is recorded in the information processing device may be any of a semiconductor medium (for example, a ROM or a non-volatile memory card), an optical recording medium/magnetic optical recording medium (for example, a digital versatile disc (DVD), magneto optical disc (MO), mini disc (MD), compact disc (CD), Blu-ray (BD; registered trademark) disc), or the like), a magnetic recording medium (for example, a magnetic tape or flexible disk), and the like. In this case, the program recorded on the recording medium is read by the computer of the information processing device and executed by the computer, such that not only the functions of the above-described embodiment are realized, but also functions of the disclosure are realized by performing processing in cooperation with an operating system, another application program, or the like based on instructions of the program.

Further, when a program is distributed in the market, the program can be stored in a portable recording medium and distributed, or can be transferred to a server computer connected via a network such as the Internet. In this case, it is obvious that a storage device of the server computer is also included in the disclosure.

Further, each functional block or feature of the device used in the above-described embodiment can be implemented and executed by an electric circuit, such as an integrated circuit or a plurality of integrated circuits. The electric circuit designed to realize the functions described herein may include a general-purpose processor, a digital signal processor (DSP), an application-specific integrated circuit (ASIC), a field programmable gate array (FPGA), another programmable logic device, a discrete gate or transistor logic, a discrete hardware component, or a combination thereof. The general-purpose processor may be a microprocessor, or any known processor, controller, microcontroller, or state machine. The electric circuit described above may be configured of a digital circuit or may be configured of an analog circuit. Further, when an integrated circuit technology for replacement into a current integrated circuit emerges with the development of semiconductor technology, a new integrated circuit based on the technology may also be used in one or more aspects of the disclosure.

What is claimed is:

1. An image forming apparatus comprising:
a toner image former that forms a toner image on paper based on image information;
a fixer that includes at least a pair of rollers and fixes the toner image formed on the paper at a pressure contact portion formed by the pair of rollers;
an adjuster that adjusts a pressure contact force in the pressure contact portion according to a paper type; and
one or more controllers that control execution of a job related to image formation via the fixer,
wherein the one or more controllers provide, to a user, a notification prompting the user to confirm the paper type of the paper being fed in a case where the paper type set for the execution of the job differs from the paper type of the fed paper.

2. The image forming apparatus according to claim 1, wherein the one or more controllers provide the notification to the user in a case where a paper jam of the paper occurs again during execution of the job resumed after the paper jam of the paper is cleared.

3. The image forming apparatus according to claim 1,
wherein the adjuster includes an adjustment member that adjusts the pressure contact force to either a first pressure contact force or a second pressure contact force weaker than the first pressure contact force, and
the one or more controllers provide, to the user, a notification prompting the user to confirm whether an adjustment position of the adjustment member is located at the first pressure contact force or the second pressure contact force depending on the paper type of the paper fed to a paper feed tray.

4. The image forming apparatus according to claim 3, wherein, in a case where the paper is paper of the paper type having a paper thickness greater than that of plain paper, the one or more controllers provide, to the user, a notification prompting the user to confirm whether the adjustment position of the adjustment member is located at the adjustment position related to the second pressure contact force.

5. The image forming apparatus according to claim 4, wherein the paper is an envelope.

6. An image forming apparatus comprising:
a toner image former that forms a toner image on paper based on image information;
a fixer that includes at least a pair of rollers and fixes the toner image formed on the paper at a pressure contact portion formed by the pair of rollers;
an adjuster that adjusts a pressure contact force in the pressure contact portion according to a paper type; and
one or more controllers that control execution of a job related to image formation via the fixer,
wherein, when a notification prompting adjustment of the pressure contact force by the adjuster is provided to a user, the one or more controllers restrict display of a selection button for receiving a selection instruction for instructing to delete the notification until a predetermined condition is satisfied.

7. The image forming apparatus according to claim 6, wherein the one or more controllers set an elapsed time from start of the notification as the predetermined condition, and display the selection button after the predetermined elapsed time has elapsed.

8. The image forming apparatus according to claim 6, further comprising a detector that detects an opening and closing operation of a cover member that covers the adjuster, wherein the one or more controllers set a detection result by the detector as the predetermined condition, and display the selection button in a case where the cover member is closed.

9. An image forming method comprising:
forming a toner image on paper based on image information;
fixing the toner image formed on the paper at a pressure contact portion formed by a pair of rollers;
adjusting a pressure contact force in the pressure contact portion according to a paper type; and
providing, to a user, a notification prompting the user to confirm the paper type of the paper being fed in a case where the paper type set for execution of a job differs from the paper type of the fed paper.
